(19) United States
(12) Patent Application Publication
(10) Pub. No.: US 2008/0148949 A1
(43) Pub. Date: Jun. 26, 2008

(54) Blending jar apparatus structured according to the geometric relationship known as Phi

(76) Inventor: David Stephen Wolfe, El Cajon, CA (US)

Correspondence Address: Mitch C. Wallis, 3657 Vermont Street, San Diego, CA, 92103, US

(21) Appl. No.: 11/643,125

(22) Filed: Dec. 21, 2006

(51) Int. Cl. B67D 1/08

(52) U.S. Cl. 99/275

(57) ABSTRACT

A blending jar apparatus is disclosed including a jar structure formed according to the geometric relationship known as Phi. Included is a blade configuration structured according to Phi. The geometric relationship between the jar and the blade configuration creates an implosion (cooling and low friction) effect rather than an explosive (heating and high friction) effect. The blade configuration may be composed of galvanized steel. Two equidistant handles may be secured to the jar by copper rivets protruding into the interior of the cavity. The galvanized steel blades in combination with the copper rivets create a negatively Charged ionic field. A method of electromagnetic field (EMF) shielding technology housed within the motor section of the device is also disclosed.

### FIELD OF THE INVENTION

This invention relates to blending devices, and more particularly to a blending device which preserves and increases the health and nutritional benefits of the ingredients.

### BACKGROUND OF THE INVENTION

Blending devices are being used now more than ever. People are increasingly becoming aware of the benefits, in terms of nutrition and taste, of well-processed high quality beverages. Blended fruit smoothies and similar fruit drinks, popular with all types of people ranging from the fitness minded to the less active, require a blending device. Cold beverages, in particular, which utilize fruit (frozen or fresh) and ice present unique challenges in beverage preparation. In addition, blending machines are ideal for mixing nutritional supplements into beverages while attempting to achieve an ideal uniform drink consistency.

In addition to smoothies, consumers are demanding more diversity and nutritional benefits in beverages. For example, different types of coffees, shakes, health drinks and the like, are now commonly served at many different types of retail business locations as well as being produced and consumed at home. The keys to producing a high quality beverage are high-quality ingredients and a high-quality blending machine that will quickly and efficiently blend the ingredients without damaging or impairing the nutritional content of the ingredients.

One problem associated with traditional blending devices is that friction and heat are produced in the blending operation. It is well known that as heat is applied to food the vitamin C content and other nutritional factors are decreased or may be completely destroyed.

Yet another problem with respect to traditional blending devices relates to positive ionization (free radical formation) which increases as the food is blended down from its natural whole state into a liquid. Traditional blending devices create a positively-charged (or an oxidized) beverage. This creates a beverage that, when consumed, robs the body of much needed negative ions and increases the presence of free radicals in the body.

Still yet another problem exists with respect to traditional blending devices, particularly electromagnetic frequencies produced by their motors. High frequency electromagnetic fields have been shown to cause positive ionization which can damage genetic material. A traditional blender, when in operation, produces a harmful, radio-wave-containing EMF field that extends out to a radius of 1-3 meters.

In view of the foregoing, there is a need to provide a blending device and method of blending which will allow beverages to be made quickly and efficiently without excessive: friction and heat, positive ionization, and the resulting damage to food nutrients and human health. There is also a need to develop a blending device that produces a beverage with an optimal, uniform consistency with respect to all ingredients. There is still further a need to develop a blending device that does not produce harmful EMF's from the operation of its motor.

### SUMMARY OF THE INVENTION

The Golden Ratio (known simply Phi) is a constant ratio derived from a geometric relationship resulting in an irrational value. The ratio is not an equal division; it is an assymetrical division, a ratio of a smaller part to a larger part equaling Phi and having a numerical value of approximately 1.618.

The present invention utilizes the Golden Ratio to determine the shape of both the jar apparatus and the blade configuration, as well as the relationship between them. Neither excessive friction nor heat is produced through the operation of the blending device. To the contrary, the temperature of the beverage fluctuates only slightly through the operation of the blending device. This preserves the nutritional value of the ingredients.

Another aspect of the present invention relates to the creation of a negative ionic charge produced through the operation of the blending device. The elements of copper and zinc, contained in the protruding handle rivets and the galvanized blade configuration, react during the operation of the blending device to produce a negative ionic charge in the liquid medium that resists oxidation. When the liquid is consumed this promotes a more complete digestion of the beverage and a better assimilation of its nutrients—especially vitamin C.

Still another aspect of the present invention relates to the shielding of harmful, radio-wave, electromagnetic frequencies (EMF's) through the operation of the blending device.

The foregoing and other features, utilities and advantages of the invention will become apparent from the following detailed description of the invention with reference to the accompanying drawings.

### BRIEF DESCRIPTION OF THE DRAWINGS

FIG. 1 is a perspective view of the jar and blending apparatus according to the present invention;

FIG. 3 is a perspective view of the lid of the jar apparatus showing the perforated holes and the twisted air shaft which allow for movement of air during operation;

FIG. 4 is a perspective view of the blending jar showing the blade assembly mounted within the jar;

FIG. 5 is a perspective view of the blade assembly;

FIG. 6 is a partial perspective view of the blending jar showing the EMF field containment;

FIG. 7 is a flow chart showing the steps utilized in EMF field containment according to the present invention;

FIG. 8 is a top view of the blade configuration;

FIG. 9 is a top view of the blade configuration showing the linear Phi relationship inherent in the length segments;

FIG. 10 is a conceptual side elevation view of the blade configuration showing the Phi relationship of its segments;

FIG. 11 is a top view of the blade configuration showing the angle of departure between the segments;

FIG. 12 is a perspective view of the blade configuration showing the angle of departure between the segments;

FIG. 13 is a perspective view of the blade configuration showing the angle of departure between the blade segments;

FIG. 14 is a partial perspective of the blending apparatus showing the connection between the jar, the blade configuration, and the stationary base.

FIG. 18 is a conceptual view of the jar showing the Phi relationship between the length and the width;

FIG. 19-20 shows the math demonstrating the inherent Phi relationships within the present invention.

### DETAILED DESCRIPTION OF THE INVENTION

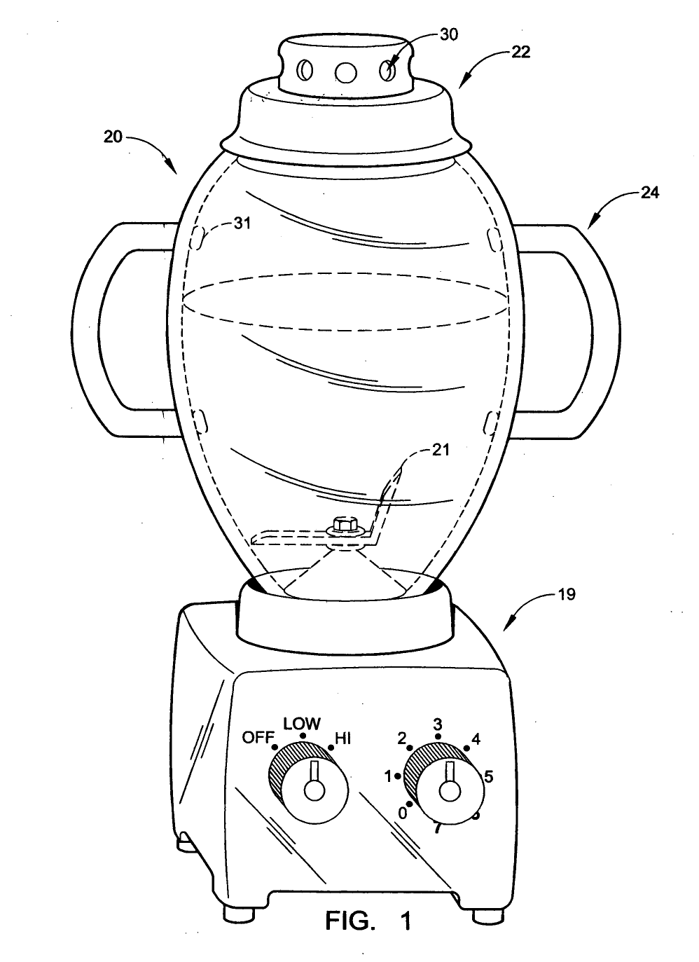

The present invention relates to a blending apparatus FIG. 1 which, in one embodiment, the blending FIG. 1 apparatus is a stand-alone, portable blending device.

The blending device FIG. 1 comprises a stationary base 19 and a mixing container or jar 20 with concentric handles 24 in which a mixing blade 21 is rotatably mounted. The blending device still further comprises a lid 22 which covers the open end of the jar during operation.

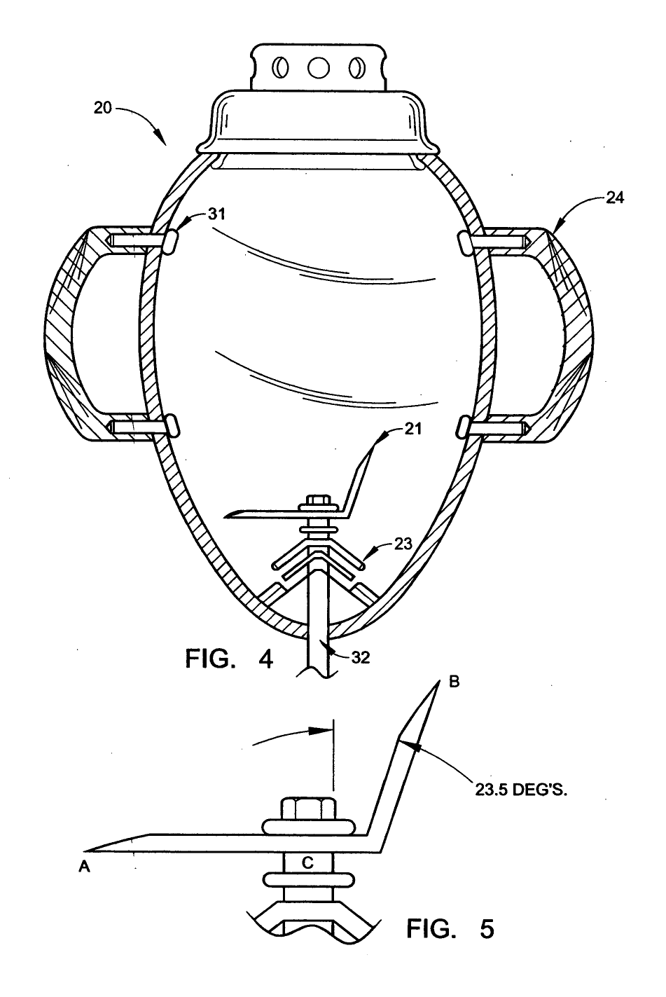

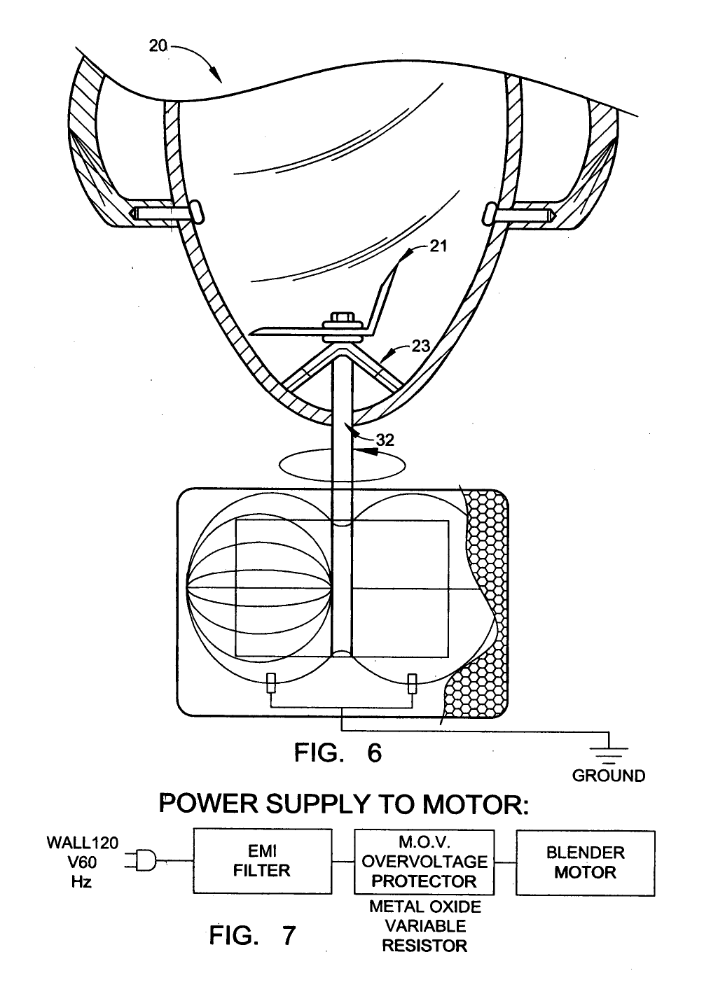

The stationary base 19, as shown in FIG. 1, serves to hold and protect the motor which drives the blending apparatus FIG. 1. Any suitable motor known to those skilled in the art may be utilized without departing from the spirit and scope of the present invention. As shown in FIG. 4-6, the stationary base further defines a mounting base 23 for the jar which serves to hold the blades 21 in place during operation.

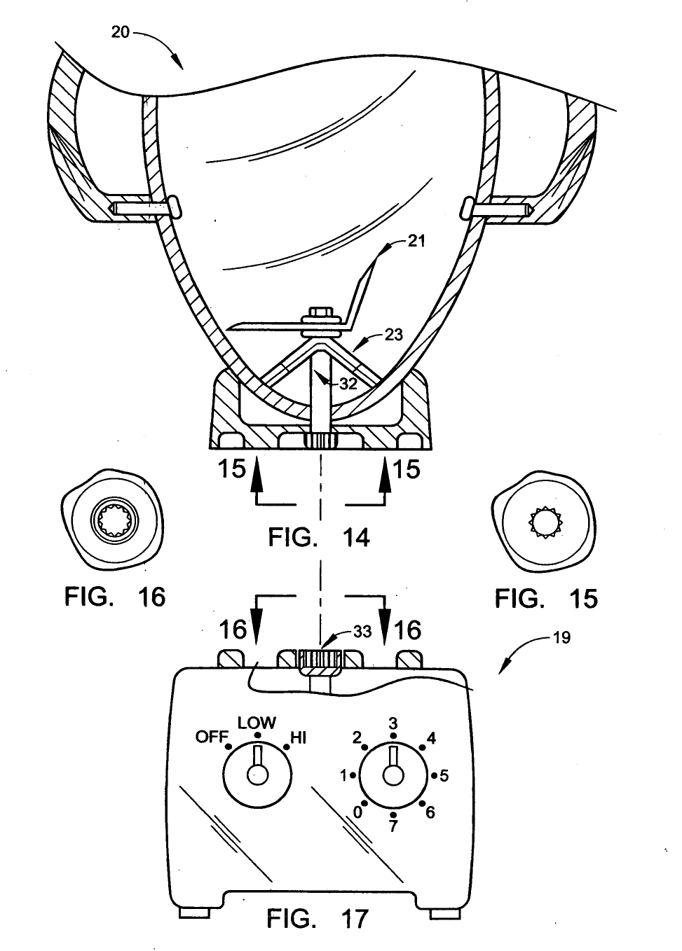

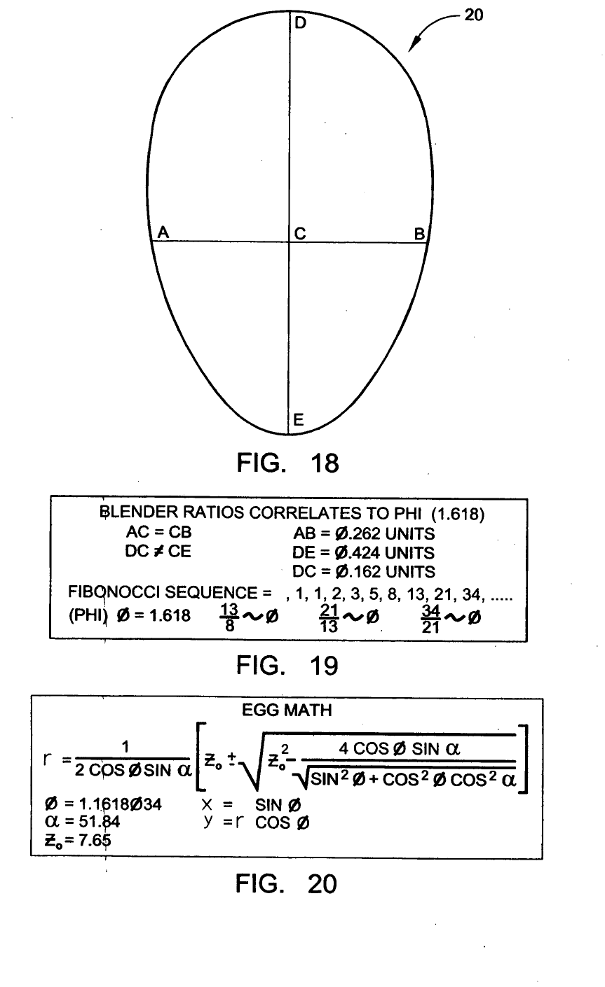

As shown in FIG. 14 a vertical drive shaft protrudes from the bottom of the jar which connects the mixing blade 21 to the coupling shaft receptacle 33 extending from the motor.

As shown in FIGS. 1, 4, and 18 the jar is shaped in accordance with the geometric relationship known as phi. The shape of the jar resembles that of an egg 20 such that the top portion of the jar comprises a larger diameter than the bottom portion (to allow ingredients to be inserted into the top of the jar). As shown in FIG. 18, the length and height of the jar are determined by the intersection of the vertical and horizontal axis such that the total height of the jar is equal to that numerical value consisting of the width of the jar plus the upper portion of the height as measured from the intersection of the two axis (where the vertical axis intersects the horizontal axis at its midpoint). The size of the jar can be increased or decreased so long as the phi relationship between the length and height is maintained.

A benefit relative to the present invention is that the egg shape of the jar provides an increase in structural integrity insofar as increasing the jar's resistance to latitudinal change or breakage.

Another novel aspect of the present jar according to the present invention is that the egg shape promotes ease of circulation of the liquid medium during operation thereby eliminating excessive friction and heating of the ingredients.

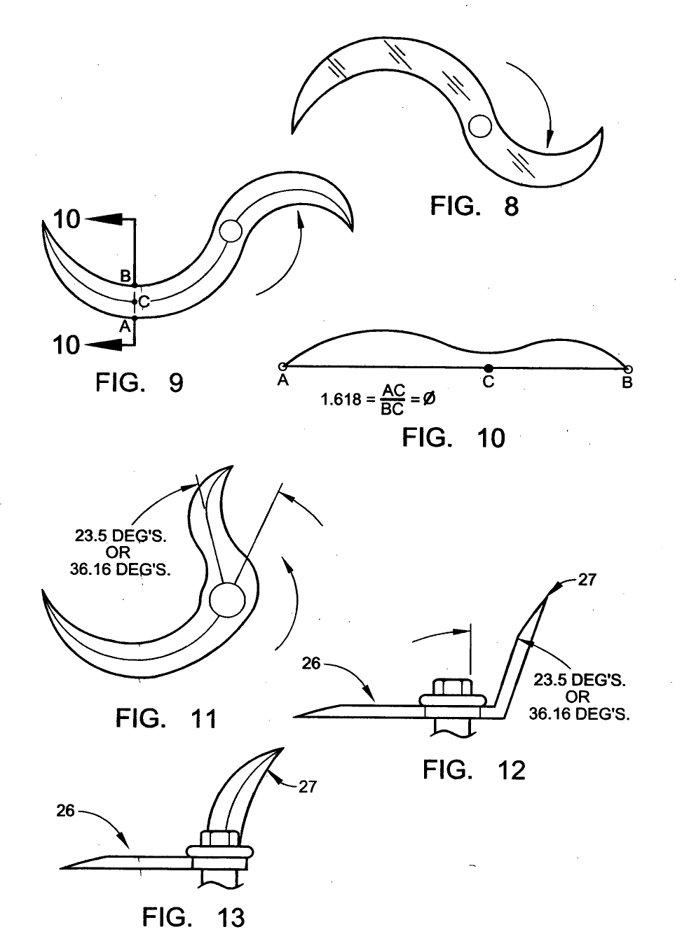

Another unique aspect of the present invention relates to the blade configuration. As shown in FIG. 8-13 the blade configuration is shaped in accordance with the geometric relationship known as phi. The blade configuration consists of a horizontal segment 26 and a vertical segment 27. The lengths of the segments comprise a phi relationship such that the horizontal segment 26 is longer than the vertical segment 27 and the sum of the two segments divided by the length of horizontal segment is equal to the length of the horizontal segment divided by the length of the vertical segment. The length of each segment may be decreased or increased so long as the phi relationship between the segments is maintained.

Another novel aspect of the blade configuration according to the present invention relates to the angle of ascent of the vertical segment 27 from the horizontal segment 26. As shown in FIGS. 5 & 12 the vertical segment 27 extends upwardly at either an angle of 23.5 degrees or 36.16 degrees from the horizontal segment 26.

A benefit relative to the blade configuration 21 is that the articulation of the blade configuration 21 in relationship to the egg shape of the jar promotes the natural geometric coiling action or vortex movement of the liquid medium during operation. Liquids have a natural tendency to form vortices especially if its flow is accelerated by an external influence. The natural spiral movement of the liquid medium in a vortex concentrates, contracts, and compacts the liquid molecules creating a cooling effect which in turn creates a partial vacuum. The articulation of the blade configuration in relationship to the egg shape of the jar creates an axis which coincides with the direction of flow of the liquid, thereby promoting maximum acceleration of velocity. The combination of the increase in velocity and the decrease in friction promotes an implosion or suctional process that causes the liquid molecules to move inwards, not outwards. This inward (centripetal) motion optimizes acceleration of the liquid molecules which in combination with negative resistance (no friction) cools the beverage during operation.

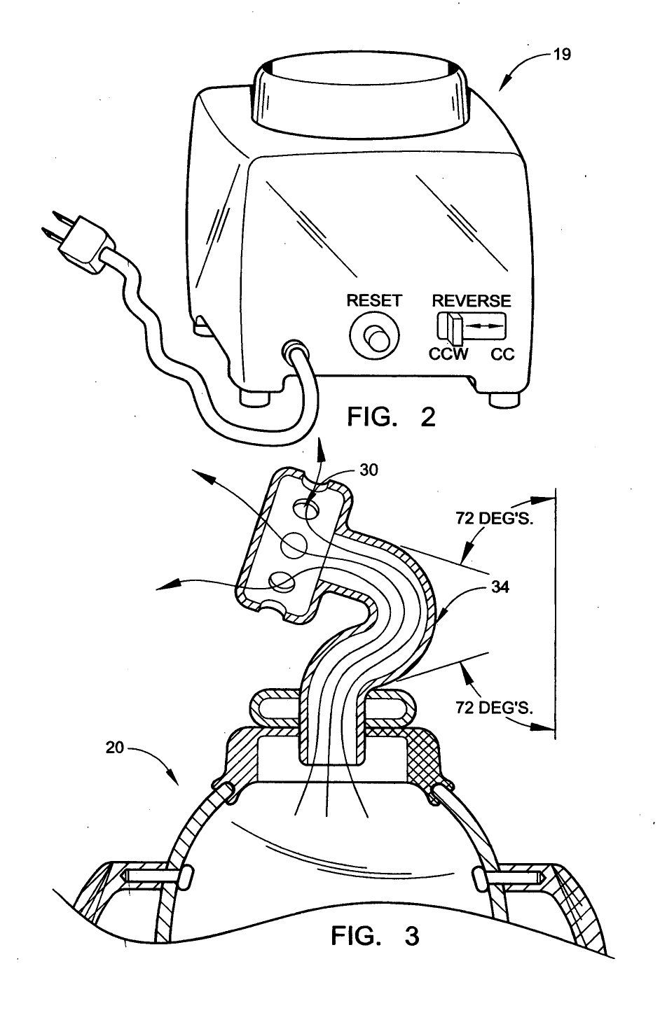

FIG. 3 shows the lid 22 of the jar. The lid configuration 22 contains perforated holes 30 which allow air from the atmosphere to enter and exit the jar during operation through the lid air shaft 34 in order to relieve pressure on the sides of the jar caused by the partial vacuum created during the implosion process. Included within the lid configuration is a hollow air shaft 34 or tube which twists above the top portion of the lid at 72 degree angles (72 degrees denotes a Phi relationship). The unique shape of the air shaft 34 promotes the movement of air in a centripetal fashion which further reduces friction and heating of the contents during operation.

Another benefit relative to the lid 22 of the jar is that the perforated holes 30 and the unique angle of the lid air shaft 34 relative to the top portion of the lid allow for the exchange of air but do not allow the contents of the jar to escape during operation.

Another unique aspect of the present invention relates to the production of a negative ionic charge in the liquid medium during operation.

FIGS. 1 & 4 show the protrusion into the jar cavity of copper rivets 31 which attach the concentric handles 24 to the jar. The blade configuration 21 is comprised of galvanized steel (zinc coated). During operation, the molecules which comprise the copper rivets 31 react with the molecules which comprise the blade configuration 21 to create a negative ionic charge within the liquid medium.

The electrons created through the negative ionization of the contents assist in the neutralization of free radicals. This is very beneficial because free radicals cause damage to cells and promote both disease and premature aging. The result of neutralizing free radicals is an increase in oxygen and energy. An increase in oxygen helps to destroy cancer cells, remove waste, carry nutrients, and also helps to resist bacteria and viruses which invade the body.

FIG. 7 shows a method of filtering electromagnetic emissions caused during operation of the present invention. A metal oxide varistor along with an EMI filter are housed within the stationary base 19. The EMI filter is comprised of a metallic meshwork net (primarily copper) which surrounds the motor.

Naturally, the context of the invention is in no way limited to the embodiments described above and variations or modifications can be made thereto without departing from the spirit and scope of the invention.

Naturally, the invention is in no way limited to the field of blending jars, and may extend to other fields, in particular to all those which use centripetal motion to reduce friction and excess heating during operation, etc.

No reference sign in the present text should be interpreted as limiting said text.

The verb “comprise” and its conjugations must also not be interpreted limitingly, i.e. they must not be interpreted as excluding the presence of steps or elements other than those defined in the description, or as excluding a plurality of steps or elements already listed after said verb and preceded by the article “a” or an

What is claimed is:

1. An apparatus, comprising:
A blending jar, the blending jar comprising:
Curvilinear walls arranged in the shape of an egg such that the top portion of the jar comprises a larger diameter than the bottom portion;
A rotatable blade configuration;
Protruding rivets which secure handles to the jar;
A perforated lid which covers the top portion of the jar.

2. An apparatus according to claim 1, wherein the jar is shaped in accordance with the geometric relationship known as phi.

3. An apparatus according to claim 1, wherein the length and height of the jar are determined by the intersection of the vertical and horizontal axis such that the total height of the jar is equal to that numerical value consisting of the width of the jar plus the upper portion of the height as measured from the intersection of the two axis (where the vertical axis intersects the horizontal axis at its midpoint).

4. An apparatus according to claim 1, wherein the blade configuration is shaped in accordance with the geometric relationship known as phi.

5. An apparatus according to claim 1, wherein the blade configuration is comprised of galvanized steel.

6. An apparatus according to claim 4, wherein the blade configuration consists of a horizontal segment and a vertical segment such that the horizontal segment is longer than the vertical segment and the sum of the two segments divided by the length of horizontal segment is equal to the length of the horizontal segment divided by the length of the vertical segment.

7. An apparatus according to claim 4, wherein the blade configuration consists of a horizontal segment and a vertical segment such that the vertical segment extends upwardly at either an angle of 23.5 degrees or 36.16 degrees from the horizontal segment.

8. An apparatus according to claim 1, wherein rivets comprised of copper protrude into the jar cavity to secure concentric handles to the jar.

9. An apparatus according to claims 5 and 8, wherein, during operation, the copper molecules react with the zinc coating to create a negative ionic charge within the liquid medium.

10. An apparatus according to claim 1, wherein the lid configuration includes a hollow shaft which twists at a specified angle above the top portion of the lid to allow air to enter and exit the jar cavity in a centripetal motion.

11. An apparatus, according to the present invention, wherein a net comprised of metallic meshwork surrounds the motor within its housing to filter electromagnetic emissions.
